(19) United States
(12) Patent Application Publication
(10) Pub. No.: US 2021/0049630 A1
(43) Pub. Date: Feb. 18, 2021

(54) AREA POPULARITY CALCULATION DEVICE

(71) Applicant: NTT DOCOMO, INC., Chiyoda-ku (JP)

(72) Inventors: Satoshi KAWASAKI, Chiyoda-ku (JP); Takeshi KAMIYAMA, Chiyoda-ku (JP); Anna OONISHI, Chiyoda-ku (JP); Yusuke FUKAZAWA, Chiyoda-ku (JP); Masatoshi KIMOTO, Chiyoda-ku (JP)

(73) Assignee: NTT DOCOMO, INC., Chiyoda-ku (JP)

(21) Appl. No.: 17/049,240

(22) PCT Filed: Mar. 4, 2019
(86) PCT No.: PCT/JP2019/008445

§ 371 Date: Oct. 20, 2020

(30) Foreign Application Priority Data
Apr. 24, 2018 (JP) 2018-083141

(51) Int. Cl. G06Q 30/02; G06Q 50/14; G06F 16/29; G06F 16/28

(52) U.S. Cl. CPC G06Q 30/0205; G06F 16/285; G06F 16/29; G06Q 50/14

(57) ABSTRACT

An area popularity calculation device 1 includes: an acquisition unit (10) configured to acquire area information representing areas on a map; an identifying unit (11) configured to identify one or more points of interest (POIs) included in a target area represented by the area information acquired by the acquisition unit; and a calculation unit (12) configured to calculate a popularity level of the target area on the basis of one or more POI popularity levels respectively associated with the one or more POIs identified by the identifying unit.

### TECHNICAL FIELD

It relates to an area popularity calculation device that calculates a popularity level of an area on a map.

### BACKGROUND ART

In Patent Document 1 described below, a navigation system that calculates popularity levels indicating degrees of height of popularity of points of interest (POI) has been disclosed.

### CITATION LIST

### Patent Literature

[Patent Literature 1] Japanese Unexamined Patent Publication No. 2017-166980

### SUMMARY OF INVENTION

### Technical Problem

Although the navigation system described above can calculate a popularity of a POI, for example, an accurate popularity of a predetermined area on a map cannot be calculated.

Thus, in view of the problems described above, an object is to provide an area popularity calculation device capable of calculating a more accurate popularity level of an area.

### Solution to Problem

In order to solve the problems described above, an area popularity calculation device according to one aspect of the present invention includes: an acquisition unit configured to acquire area information representing areas on a map; an identifying unit configured to identify one or more points of interest (POIs) included in a target area represented by the area information acquired by the acquisition unit; and a calculation unit configured to calculate a popularity level of the target area on the basis of one or more POI popularity levels respectively associated with the one or more POIs identified by the identifying unit.

According to such an area popularity calculation device, a popularity level of an area on a map can be calculated. In addition, since a popularity level of an area is calculated on the basis of one or more POI popularity levels respectively associated with one or more POIs included in the area, for example, a more accurate popularity level of an area such as a popularity level of an area including one or more POIs having high POI popularity levels being higher and a popularity level of an area including one or more POIs having low POI popularity levels being lower can be calculated.

### Advantageous Effects of Invention

A more accurate popularity level of an area can be calculated.

### BRIEF DESCRIPTION OF DRAWINGS

FIG. 1 is a functional block diagram of an area popularity calculation device according to a first embodiment.

FIG. 2 is a diagram illustrating an example of a table of a POI category master.

FIG. 3 is a diagram illustrating an example of a table of a POI master.

FIG. 4 is a diagram illustrating an example of a table of POI popularity information.

FIG. 5 is a flowchart illustrating a process executed by the area popularity calculation device according to the first embodiment.

FIG. 6 is a functional block diagram of an area popularity calculation device according to a second embodiment.

FIG. 7 is a diagram illustrating an example of a table of an event category master.

FIG. 8 is a diagram illustrating an example of a table of event information.

FIG. 9 is a diagram illustrating a display example of a display based on a popularity level.

FIG. 10 is a flowchart illustrating a process executed by the area popularity calculation device according to the second embodiment.

FIG. 11 is a functional block diagram of an area popularity calculation device according to a third embodiment.

FIG. 12 is a flowchart illustrating a process executed by the area popularity calculation device according to the third embodiment.

FIG. 13 is a hardware configuration diagram of an area popularity calculation device according to an embodiment of the present invention.

### DESCRIPTION OF EMBODIMENTS

Hereinafter, area popularity calculation devices according to embodiments will be described in detail with reference to the drawings. In description of the drawings, the same reference signs will be assigned to the same elements, and duplicate description will be omitted. In addition, the embodiments in the following description are specific examples of the present invention, and the present invention is not limited to such embodiments unless otherwise mentioned.

### First Embodiment

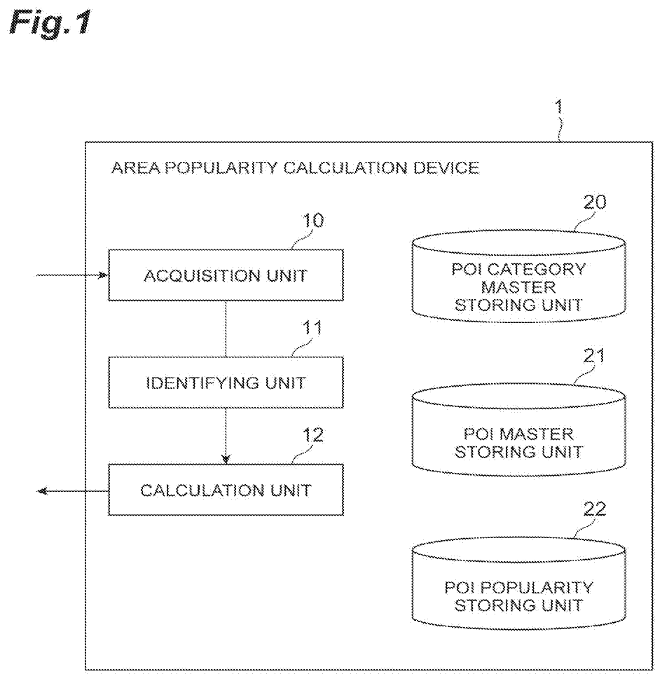

FIG. 1 is a functional block diagram of an area popularity calculation device 1 according to a first embodiment. As illustrated in FIG. 1, the area popularity calculation device 1 is configured to include an acquisition unit 10, an identifying unit 11, a calculation unit 12, a POI category master storing unit 20, a POT master storing unit 21, and a POI popularity storing unit 22. The area popularity calculation device 1 is a computer apparatus such as a server.

Hereinafter, each functional block of the area popularity calculation device 1 illustrated in FIG. 1 will be described. First, the storing units will be described.

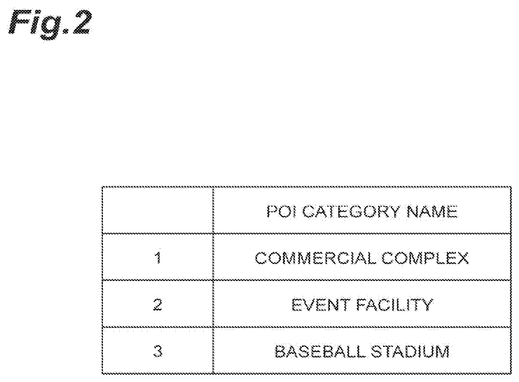

The POI category master storing unit 20 stores a POI category master that is table data of master data of categories of POIs (POI categories). A point of interest (POI) is a specific point (a location, a facility, a store, a target object, or the like) of users' interest on a map. In this specification, although a POI will be mainly described as a facility, the POI is not limited thereto. FIG. 2 is a diagram illustrating an example of a table of a POI category master stored using the POI category master storing unit 20. As illustrated in the example of the table illustrated in FIG. 2, the POI category master includes names of POI categories (POI category names). As specific examples of the POI category names, as illustrated in the example of the table illustrated in FIG. 2, there are “commercial complex”, “event facility”, “baseball stadium”, and the like.

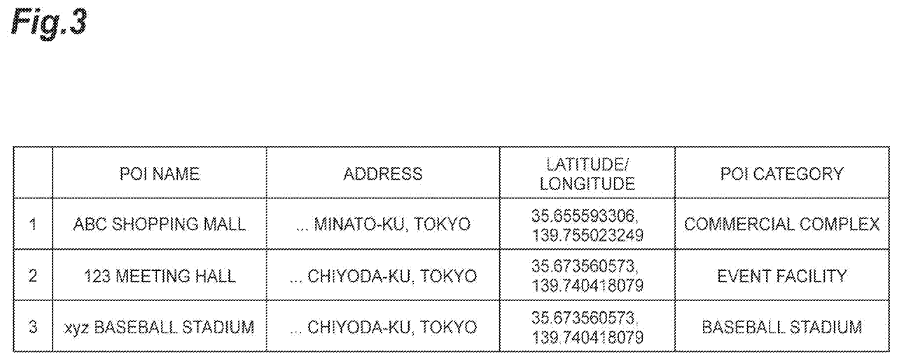

The POI master storing unit 21 stores a POI master that is table data of master data of POIs. FIG. 3 is a diagram illustrating an example of a table of a POI master. As illustrated in the example of the table illustrated in FIG. 3, the POI master includes a name of a POI (a POI name), an address at which the POI is located, a latitude/longitude at which the POI is located, and a POI category of the POI in association with each other. In addition, a POI category included in the POI master is associated with a POT category name of the POI category master described above. For example, a first record of the POI master illustrated in FIG. 3 represents that an address of a POI of which a POI name is “ABC shopping mall” and a POI category is “Commercial complex” is “ . . . Minato-Ku, Tokyo”, and the latitude/longitude thereof is “35.655593306, 139.755023249”.

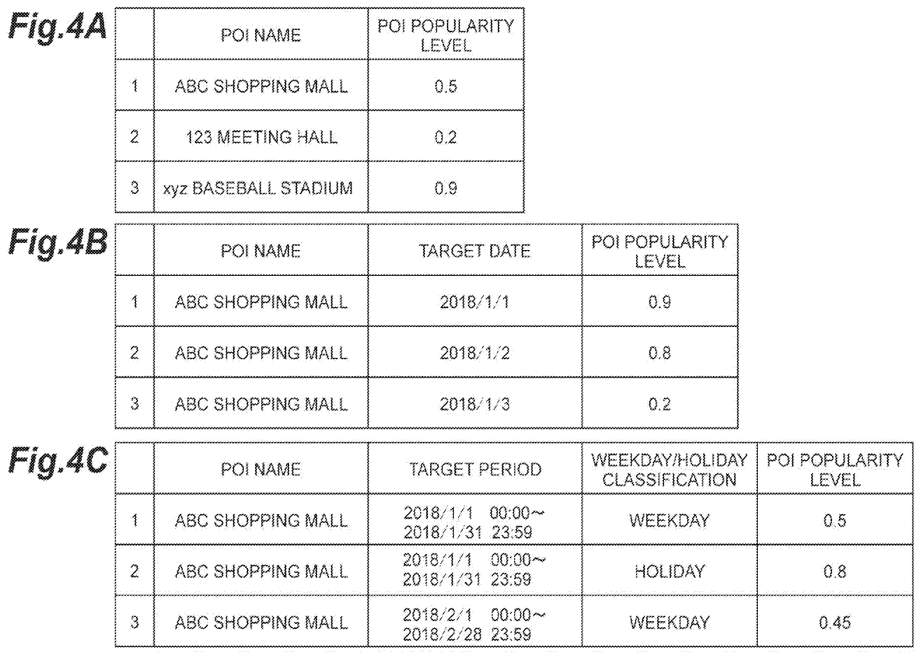

The POI popularity storing unit 22 stores POI popularity information that is table data of popularity levels of POIs (POI popularity levels). A popularity level is a value that indicates a degree of popularity among users and indicates that the popularity becomes lower as the value becomes smaller and indicates that the popularity becomes higher as the value becomes larger. The popularity level has been adjusted in advance such that the range of values thereof is equal to or larger than “0” and is equal to or smaller than “1”. Each of FIGS. 4(a), 4(b), and 4(c) is a diagram illustrating an example of a table of POI popularity information. In this specification, three variations (FIGS. 4(a), 4(b), and 4(c)) of POI popularity information will be described. The POI popularity information illustrated in FIG. 4(a) is mainly used in this first embodiment, the POI popularity information illustrated in FIG. 4(b) is mainly used in a second embodiment, and the POI popularity information illustrated in FIG. 4(c) is mainly used in a third embodiment.

In the example of the table illustrated in FIG. 4(a), POI popularity information includes a POI name, and a POI popularity level of the corresponding POI in association with each other. A POI name included in the POI popularity information is associated with a POI name of the POI master described above. For example, a first record of the POI popularity information illustrated in FIG. 4(a) represents that a popularity level of a POI of which a POI name is “ABC shopping mall” is “0.5”.

In the example of the table illustrated in FIG. 4(b), the POI popularity information includes a POI name, a target date at which a POI popularity level of the corresponding POI was set, and the POI popularity level of the POI in association with each other. For example, a first record of the POI popularity information illustrated in FIG. 4(b) represents that a popularity level of the POI of which the POI name is “ABC shopping mall” on “Jan. 1, 2018” was “0.9”. In other words, in variations of the POI popularity information illustrated in FIG. 4(b), the POI popularity level is associated with one date.

In the example of the table illustrated in FIG. 4(c), the POI popularity information includes a POI name, a target period for which a POI popularity level of the corresponding POI was set, a weekday/holiday classification for which a POI popularity level of the POI was set, and the POI popularity level of the POI in association with each other. For example, the POI popularity information illustrated in FIG. 4(c) represents that, for a POI of which a POI name is “ABC shopping mall”, a popularity level of “weekday” during “January 2018” was “0.5”, a popularity level of “holiday” during “January 2018” was “0.8”, and a popularity level of “weekday” during “February 2018” was “0.45”. The target period and the weekday/holiday classification together are a period. In other words, in variations of the POI popularity information illustrated in FIG. 4(c), a POI popularity level is associated with one period.

The acquisition unit 10 acquires area information that represents an area on a map. An area is a region, a range, or the like having an area surrounded by a polygon, a circle, straight lines, curved lines, and the like. As a specific example of the area information, for example, in a case in which the area is an area surrounded by a rectangle, there is information indicating that the area is the rectangle and information including the latitude/longitude of each of four vertexes of the rectangle. As specific examples of an area represented by the area information, there are the whole or a part of a screen area displayed in a user's client terminal that can access the area popularity calculation device 1 through a network, an area on a map that is designated by the user, a town/village boundary on a map, and the like. The acquisition unit 10 outputs the acquired area information to the identifying unit 11.

The identifying unit 11 identifies POIs included in an area (a target area) represented by area information acquired (output) by the acquisition unit 10. For example, in a case in which the area information is information indicating that a corresponding area has a rectangular shape and information including the latitude/longitude of each of four vertexes of the rectangle, the identifying unit 11 identifies a record of which this latitude/longitude are included in a rectangle (positioned inside the rectangle) represented by the latitude/longitude of each of the four vertexes in accordance with the area information, in other words, a POI in the POI master stored by the POI master storing unit 21. One or a plurality of POIs may be identified by the identifying unit 11. The identifying unit 11 outputs POI identification information relating to the identified POT (for example, a POI name) to the calculation unit 12. In addition, in a case in which there is no POI included in the target area, in other words, in a case in which no POI has been able to be identified, the identifying unit 11 outputs information indicating that no POI has been able to be identified to the calculation unit 12.

The calculation unit 12 calculates a popularity level of a target area on the basis of POI popularity levels associated with POIs identified by the identifying unit 11. More specifically, when POI identification information is input from the identifying unit 11, the calculation unit 12 extracts a POT popularity level of each POI represented by the POI identification information from the POI popularity information stored by the POI popularity storing unit 22. For example, in a case in which the POI identification information input from the identifying unit 11 is POI name “ABC shopping mall”, the calculation unit 12 refers to the POI popularity information illustrated in FIG. 4(a) and extracts a POI popularity level “0.5” associated with the POI name. Subsequently, the calculation unit 12 calculates a popularity level of the target area on the basis of one or more POI popularity levels that have been extracted. For example, the calculation unit 12 may calculate a total value acquired by summing one or more POI popularity levels that have been extracted and calculate the calculated total value as a popularity level of the target area. In addition, the calculation unit 12 may refer to a correspondence table, in which a correspondence relation between a total value and a popularity level is set, which has been stored in the area popularity calculation device 1 in advance, extract a popularity level corresponding to the calculated total value, and calculate the extracted popularity level as a popularity level of the target area. The calculation unit 12 may output the calculated popularity level of the target area to another functional block of the area popularity calculation device 1, output the calculated popularity level to a client terminal through a network, or output the calculated popularity level to another device through a network. When information indicating that no POI has been able to be identified is input from the calculation unit 12, the calculation unit 12 may output an error or stop the process.

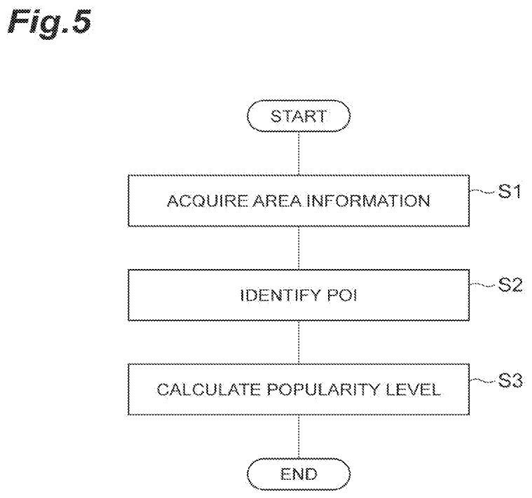

FIG. 5 is a flowchart illustrating a process (an area popularity calculating method) executed by the area popularity calculation device 1 according to this first embodiment. First, area information representing an area on a map is acquired by the acquisition unit 10 (Step S1). Next, POIs included in a target area represented by the area information acquired in S1 are identified by the identifying unit 11 (Step S2). Next, a popularity level of the target area is calculated on the basis of POI popularity levels associated with POIs identified in S2 by the calculation unit 12 (Step S3).

Next, operations and effects of the area popularity calculation device 1 configured as in this first embodiment will be described.

According to the area popularity calculation device 1 according to this first embodiment, a popularity level of an area on a map can be calculated. In addition, since a popularity level of an area is calculated on the basis of POI popularity levels associated with POIs included in the area, for example, a more accurate popularity level of an area such as a popularity level of an area including POIs having high POI popularity levels being higher and a popularity level of an area including POIs having low POI popularity levels being lower can be calculated.

### Second Embodiment

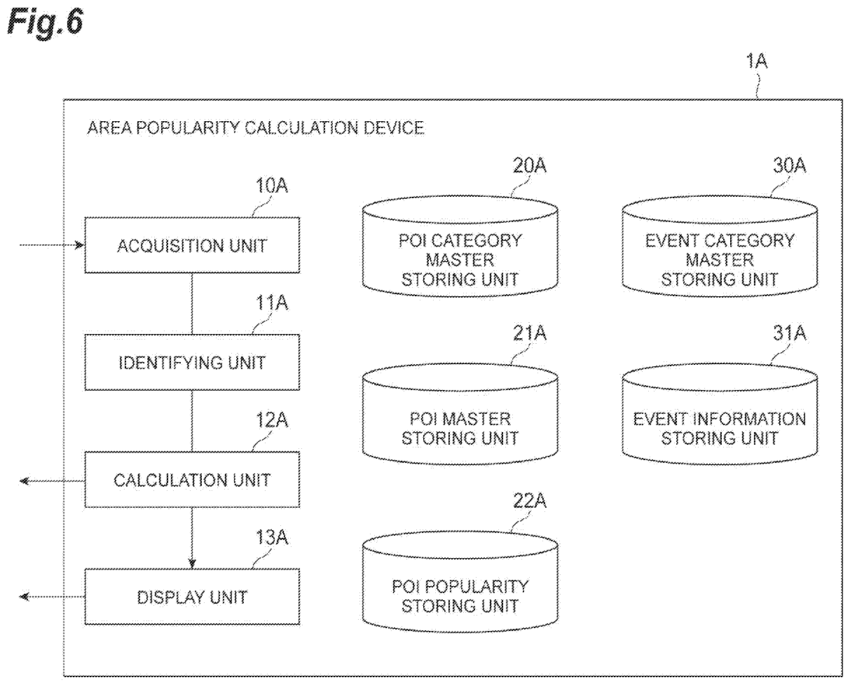

FIG. 6 is a functional block diagram of an area popularity calculation device 1A according to a second embodiment. As illustrated in FIG. 6, the area popularity calculation device 1A is configured to include an acquisition unit 10A, an identifying unit 11A, a calculation unit 12A, a display unit 13A, a POI category master storing unit 20A, a POI master storing unit 21A, a POI popularity storing unit 22A, an event category master 30A, and an event information storing unit 31A. In addition, the area popularity calculation device 1A, the acquisition unit 10A, the identifying unit 11A, the calculation unit 12A, the POI category master storing unit 20A, the POI master storing unit 21A, and the POI popularity storing unit 22A are respectively similar to the area popularity calculation device 1, the acquisition unit 10, the identifying unit 11, the calculation unit 12, the POI category master storing unit 20, the POI master storing unit 21, and the POI popularity storing unit 22 according to the first embodiment, and only differences therebetween will be described in the second embodiment.

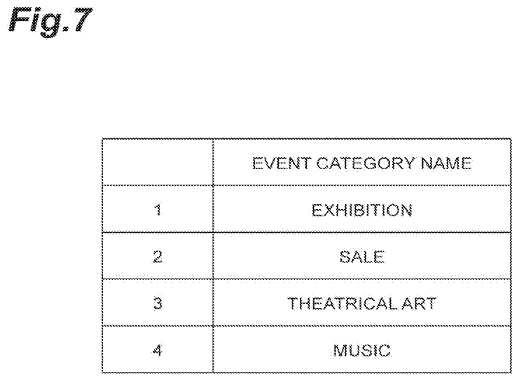

The event category master 30A stores an event category master that is table data of master data of categories of events (event categories). An event is a meeting or an event that is performed at a POI. In addition, “is performed” may only represent “is currently being performed” or may represent including at least one of “performed in the past” and “being planned to be performed in the future”. FIG. 7 is a diagram illustrating an example of a table of an event category master that is stored by the event category master 30A. As illustrated in the example of the table in FIG. 7, the event category master includes names of event categories (event category names). As specific examples of names of event categories, as illustrated in the example of the table in FIG. 7, there are “Exhibition”, “Sale”, “Theatrical art”, “Music”, and the like.

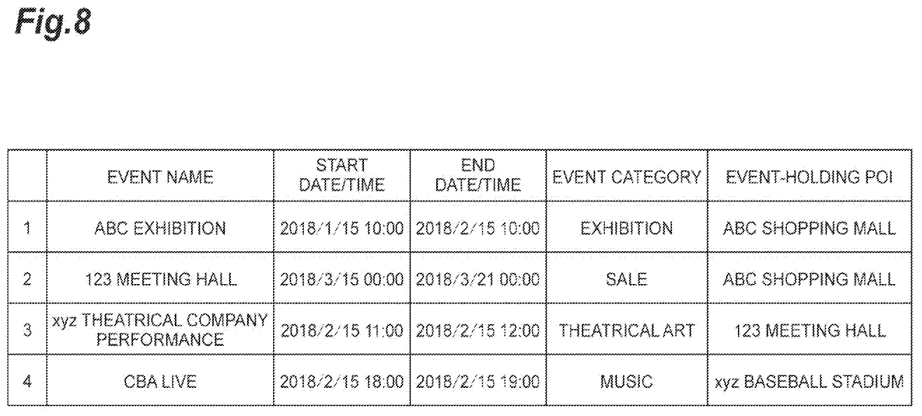

The event information storing unit 31A stores event information that is table data of events. FIG. 8 is a diagram illustrating an example of a table of event information. As illustrated in the example of the table in FIG. 8, the event information includes a name of an event (an event name), a start date/time of the event, an end date/time of the event, an event category of the event, and a POI at which the event is performed (held) (an event holding POI) in association with each other. In addition, an event category included in the event information is associated with an event category name of the event category master described above, and an event-holding POI included in the event information is associated with a POI name of the POI master stored by the POI master storing unit 21A. For example, a first record of the event information illustrated in FIG. 8 represents that an event of which the event name is “ABC exhibition” and the event category is “Exhibition” is held at “ABC shopping mall” from “10 o'clock on Jan. 15, 2018” to “10 o'clock on Feb. 15, 2018”.

The identifying unit 11A further identifies events performed inside the target area represented by the area information acquired (output) by the acquisition unit 10A. More specifically, after identifying a POI included in the target area, the identifying unit 11A identifies a record of which the event-holding POI coincides with the identified POI in the event information, in other words, an event stored by the event information storing unit 31A. One or a plurality of events may be identified by the identifying unit 11A. The identifying unit 11A outputs event identification information (for example, an event name) relating to the identified event to the calculation unit 12A. In addition, in a case in which there are no events included in the target area, in other words, in a case in which no events were able to be identified, the identifying unit 11A outputs information indicating that no events were able to be identified to the calculation unit 12A.

The calculation unit 12A may calculate a popularity level also on the basis of the event identified by the identifying unit 11A. In other words, the calculation unit 12A calculates a popularity level of the target area on the basis of POI popularity levels associated with POIs identified by the identifying unit 11A and events identified by the identifying unit 11A. The calculation unit 12A may calculate a number of events by performing weighting based on POI popularity levels respectively associated with POIs at which the events are performed and calculate a popularity level on the basis of the calculated numbers. For example, in a case in which POIs identified by the identifying unit 11A are “ABC shopping mall” and “123 meeting hall”, and events identified by the identifying unit 11A are “ABC exhibition”, “123 campaign”, and “xyz theatrical company performance”, the calculation unit 12A refers to the event information, which is illustrated in FIG. 8, stored by the event information storing unit 31A, multiplies two (weights), which is the number of events in “ABC exhibition” and “123 campaign” performed at the POI “ABC shopping mall” by a POI popularity level “0.5” associated with the POI “ABC shopping mall” (extracted by referring to the POI popularity information, which is illustrated in FIG. 4(a), stored by the POI popularity storing unit 22A), and similarly multiplies one, which is the number of events in “xyz theatrical company performance” performed at the POI “123 meeting hall”, by a POI popularity level “0.2” associated with the POI “123 meeting hall”, thereby calculating numbers. In other words, the calculation unit 12A calculates a number “1.2” using the expression “2*0.5+1*0.2”. Subsequently, the calculation unit 12A calculates a popularity level on the basis of the calculated number “1.2”.

When weighting is performed, the calculation unit 12A may perform weighting based on a POI popularity level associated with each date of a period during which each event is performed. For example, in a case in which, for one event “xyz theatrical company performance” performed at the POI “123 meeting hall” over three days, a POI popularity level of the POI “123 meeting hall” for the first day is “0.3”, a POI popularity level for the second day is “0.8”, and a POI popularity level for the third day is “0.7” (extracted by referring to the POI popularity information, which is illustrated in FIG. 4(b), stored by the POI popularity storing unit 22A), the calculation unit 12A, for example, calculates a number “0.6” using the expression “1*(0.3+0.8+0.7)/3”.

In addition, similar to a third embodiment to be described below, the calculation unit 12A may perform weighting based on a POI popularity level associated with not every day but each time period (each month, each quarter, each weekday, or each national holiday). Then, in a case in which an event spans a plurality of days, the calculation unit 12A may proportionally sum POI popularity levels in accordance with a proportion of weekdays and national holidays or a proportion of the number of days of a performance period in a certain month.

The calculation unit 12A may calculate a popularity level for each category of events. For example, the calculation unit 12A may refer to an event category of the event information, which is illustrated in FIG. 8, stored by the event information storing unit 31A and separately perform the calculation of a popularity level described above for each event category.

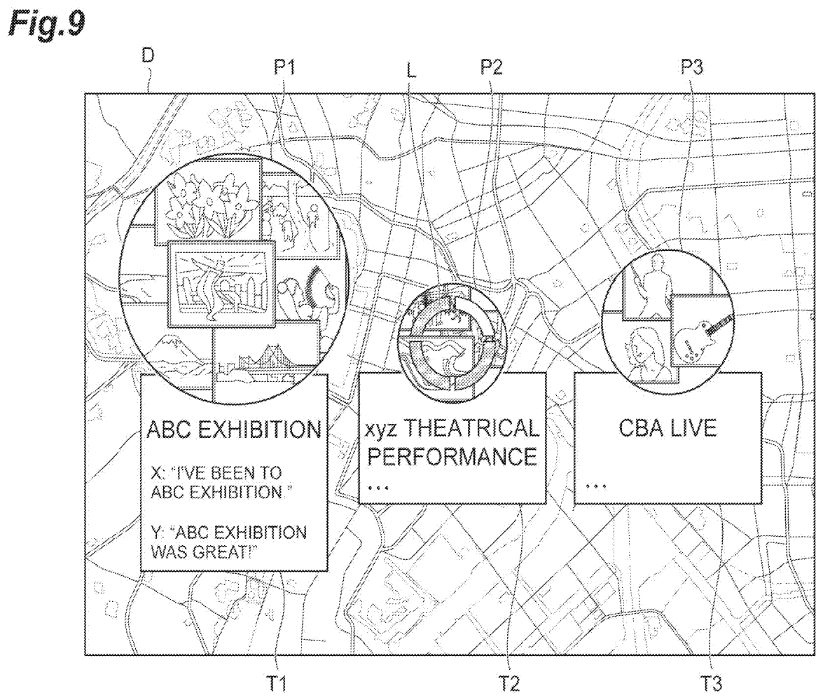

The display unit 13A performs display based on the popularity level calculated by the calculation unit 12A. The display unit 13 may perform display according to the calculated number. The display unit 13 may additionally display information relating to a period in which each event is performed. The display unit 13 may display information relating to POIs associated with POI popularity levels higher than a predetermined criterion. FIG. 9 is a diagram illustrating a display example of display based on popularity levels. In FIG. 9, a target area D is illustrated, and a set of T1 and P1, a set of T2 and P2, and a set of T3 and P3 represent information relating to categories having the three highest ranked popularity levels among popularity levels for each category of events calculated by the calculation unit 12A. The set of T1 and P1 represents information relating to the category “Exhibition” with the first popularity level. The set of T2 and P2 represents information relating to the category “Theatrical art” with the third popularity level. The set of T3 and P3 represents information relating to the category “Music” with the second popularity level. Photographs relating to the categories are respectively included inside P1 to P3, and text information relating to the categories is included inside T1 to T3.

Here, the display unit 13 changes the size of circles of P1 to P3 in accordance with the calculated numbers (after weighting). In other words, the display unit 13 makes the size of each circle which is displayed become larger as a calculated number becomes larger. In addition, four figures having a Baumkuchen shape are drawn inside P2, and three figures among them are colored. This represents that ¾ of a performance period of a most recent event among events inside the category of P2 has already ended, in other words, passed an end time. In other words, the display unit 13 additionally displays information relating to a period in which each event is performed. In addition, inside T1, contribution information relating to an event that is performed at a POI with which a POI popularity level higher than a predetermined criterion is associated is representatively displayed. In other words, the display unit 13 displays information relating to a POI with which a POI popularity level higher than a predetermined criterion is associated.

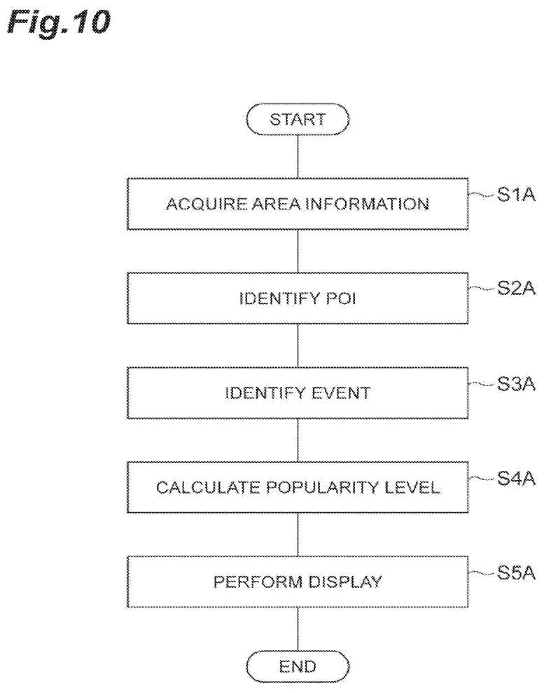

FIG. 10 is a flowchart illustrating a process (an area popularity calculation method) executed by the area popularity calculation device 1A according to this second embodiment. First, area information representing areas on a map is acquired by the acquisition unit 10A (Step S1A). Next, POIs included in a target area represented by the area information acquired in S1A are identified by the identifying unit 11A (Step S2A). Next, events performed in the target area are identified by the identifying unit 11A (Step S3A). Next, a popularity level of the target area is calculated on the basis of a POI popularity level associated with the POI identified in S2A and the events identified in S3A by the calculation unit 12A (Step S4A). Next, display based on the popularity level calculated in S4A is performed by the display unit 13A (Step SSA).

Next, operations and effects of the area popularity calculation device 1A configured as in this second embodiment will be described.

According to the area popularity calculation device 1A of this second embodiment, the identifying unit 11A further identifies events performed inside a target area, and the calculation unit 12A calculates a popularity level further on the basis of the events identified by the identifying unit 11A. In this way, since a popularity level is calculated additionally on the basis of events performed inside a target area, a more accurate popularity level of the area with events taken into account can be calculated.

In addition, according to the area popularity calculation device 1A of this second embodiment, the calculation unit 12A calculates the number of events by performing weighting based on a POI popularity level associated with a POI at which each event is performed and calculates a popularity level on the basis of the calculated number. In this way, since the number of events is calculated by performing weighting based on a POI popularity level associated with a POI at which each event is performed, for example, a more accurate popularity level of the area that is close to an actual feeling of a user can be calculated by reflecting a POI having higher popularity in the popularity level with a higher weighting factor or the like.

In addition, according to the area popularity calculation device 1A of this second embodiment, a POI popularity level is associated with each day, and, when the weighting is performed, the calculation unit 12A performs weighting based on a POI popularity level associated with each day of a period in which each event is performed. In this way, a more accurate popularity level of an area can be calculated with a POI popularity level of each day taken into account.

In addition, according to the area popularity calculation device 1A of this second embodiment, the display unit 13A that performs display on the basis of popularity levels calculated by the calculation unit 12A is further included, and the display unit 13A performs display according to the calculated numbers. In this way, for example, display that is beneficial to a user such as a display being configured to become more visually prominent as the calculated number becomes larger, in other words, as the popularity level becomes higher or the like can be performed.

In addition, according to the area popularity calculation device 1A of this second embodiment, the display unit 13A that performs display on the basis of popularity levels calculated by the calculation unit 12A is further included, and the display unit 13A additionally displays information relating to a period in which each event is performed. In this way, for example, display that is beneficial to a user such as display in which the user can easily ascertain a period in which each event is performed can be performed.

In addition, according to the area popularity calculation device 1A of the second embodiment, the calculation unit 12A calculates a popularity level for each category of events. In this way, since a popularity level of an area can be calculated for each category, display that is beneficial to a user can be performed.

In addition, according to the area popularity calculation device 1A of this second embodiment, the display unit 13A that performs display on the basis of popularity levels calculated by the calculation unit 12A is further included, and the display unit 13A displays information relating to a POI associated with a POI popularity level higher than a predetermined criterion. In this way, for example, display that is beneficial to a user such as display enabling the user to easily ascertain information relating to a POI associated with a high POI popularity level or the like can be performed.

### Third Embodiment

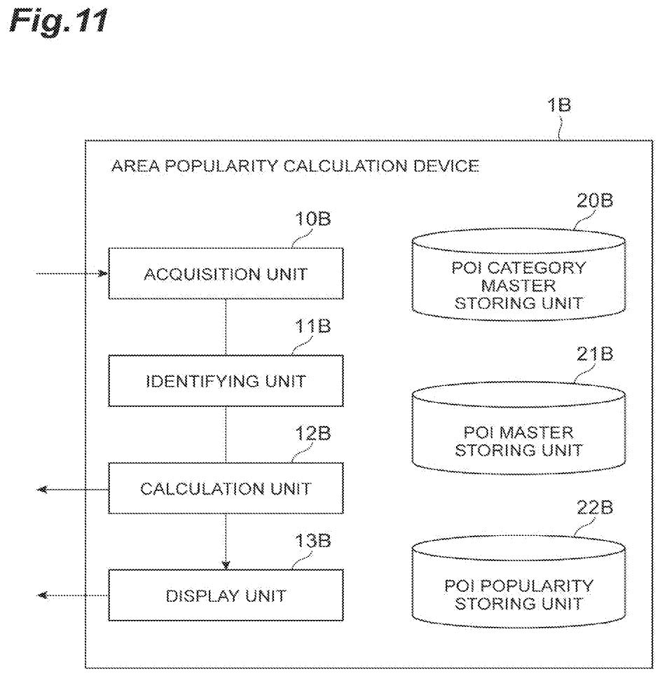

FIG. 11 is a functional block diagram of an area popularity calculation device 1B according to a third embodiment. As illustrated in FIG. 11, the area popularity calculation device 1B is configured to include an acquisition unit 10B, an identifying unit 11B, a calculation unit 12B, a display unit 13B, a POI category master storing unit 20B, a POI master storing unit 21B, and a POI popularity storing unit 22B. In addition, the area popularity calculation device 1B, the acquisition unit 10B, the identifying unit 11B, the calculation unit 12B, the POI category master storing unit 20B, the POI master storing unit 21B, and the POI popularity storing unit 22B are respectively similar to the area popularity calculation device 1, the acquisition unit 10, the identifying unit 11, the calculation unit 12, the POI category master storing unit 20, the POI master storing unit 21, and the POI popularity storing unit 22 according to the first embodiment, and only differences therebetween will be described in this third embodiment.

The calculation unit 12B calculates the number of POIs by performing weighting based on a POI popularity level associated with a predetermined time period of each POI and calculates a popularity level on the basis of the calculated number. More specifically, the calculation unit 12B calculates the number of POIs identified by the identifying unit 11B by performing weighting based on a POI popularity level (extracted by referring to the POI popularity information, which is illustrated in FIG. 4(c), stored by the POI popularity storing unit 22B) associated with a predetermined time period of each POI and calculates a popularity level on the basis of the calculated number. Similar to the POI popularity information, which is illustrated in FIG. 4(c), stored by the POI popularity storing unit 22B, a POI popularity level is individually set for each time period (each month, each quarter, each weekday, each public holiday, or the like).

The display unit 13B performs display based on popularity levels calculated by the calculation unit 12B. The display unit 13B may perform display according to the calculated number. The display unit 13 may display information relating to POIs associated with POI popularity levels higher than a predetermined criterion. The description thereof is similar to the description of the second embodiment described above, and thus the description will be omitted.

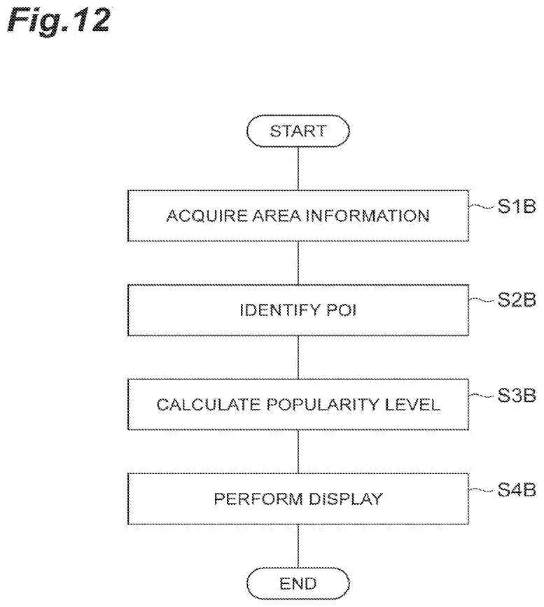

FIG. 12 is a flowchart illustrating a process (an area popularity calculation method) executed by the area popularity calculation device 1B according to this third embodiment. First, area information representing areas on a map is acquired by the acquisition unit 10B (Step S1B). Next, POIs included in a target area represented by the area information acquired in S1B are identified by the identifying unit 11B (Step S2B). Next, the number of POIs identified in S2B is calculated by the calculation unit 12B by performing weighting based on POI popularity levels associated with a predetermined time period of the POIs, and a popularity level is calculated on the basis of the calculated number (Step S3B). Next, display based on the popularity level calculated in S3B is performed by the display unit 13B (Step S4B).

Next, operations and effects of the area popularity calculation device 1B configured as in this third embodiment will be described.

According to the area popularity calculation device 1B of this third embodiment, a POI popularity level is associated with each time period, the calculation unit 12B calculates the number of POIs by performing weighting on the basis of a POI popularity level associated with a predetermined period of each POI and calculates a popularity level on the basis of the calculated number. In this way, a more accurate popularity level of an area with a POI popularity level for each time period (for which the POI popularity level changes) taken into account can be calculated.

As described above, in the area popularity calculation device 1, the area popularity calculation device 1A, and the area popularity calculation device 1B, by multiplying the number of POIs or the number of events by a POI popularity level as a weighting factor, a POI or an event having high popularity is reflected with a higher weighting factor. In this way, the weighting factor of a POI or an event having a low popularity level becomes small, and therefore, a popularity level closer to a user's actual feeling such as a popularity level in which a POI genre or an event that is more distinctive becomes a high rank or the like can be calculated.

The block diagrams used in the description of the first embodiment, the second embodiment, and the third embodiment represent blocks in functional units. Such functional blocks (constituent units) are realized by an arbitrary combination of hardware and/or software. In addition, a means that realizes each functional block is not particularly limited. In other words, each functional block may be realized by one device that is combined physically and/or logically or may be realized by directly and/or indirectly (for example, in a wired manner and/or a wireless manner) connecting two or more devices that are separated physically and/or logically and using the plurality of devices.

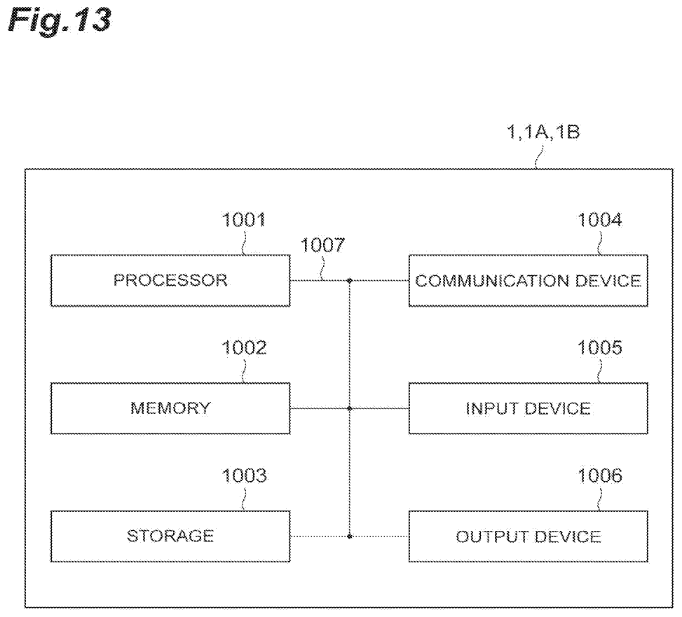

For example, the area popularity calculation device 1 according to the first embodiment, the area popularity calculation device 1A according to the second embodiment, the area popularity calculation device 1B according to the third embodiment, and the like may function as a computer performing the process of an area popularity calculation method according to one embodiment of the present invention. FIG. 13 is a diagram illustrating one example of the hardware configuration of the area popularity calculation device 1 according to the first embodiment, the area popularity calculation device 1A according to the second embodiment, and the area popularity calculation device 1B according to the third embodiment. The area popularity calculation device 1, the area popularity calculation device 1A, and the area popularity calculation device 1B described above may be physically configured as a computer device including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of each of the area popularity calculation device 1, the area popularity calculation device 1A, and the area popularity calculation device 1B may be configured to include one or a plurality of devices illustrated in the drawings or may be configured not to include some of the devices.

Each function of the area popularity calculation device 1, the area popularity calculation device 1A, and the area popularity calculation device 1B is realized by the processor 1001 performing an arithmetic operation and controlling communication using the communication device 1004 and data reading and/or writing for the memory 1002 and the storage 1003 by causing the processor 1001 to read predetermined software (a program) onto hardware such as the memory 1002 or the like.

The processor 1001, for example, controls the entire computer by operating an operating system. The processor 1001 may be configured by a central processing unit (CPU) including an interface with peripheral devices, a control device, an arithmetic operation device, a register, and the like. For example, the acquisition unit 10, the acquisition unit 10A, the acquisition unit 10B, the identifying unit 11, the identifying unit 11A, the identifying unit 11B, the calculation unit 12, the calculation unit 12A, the calculation unit 12B, the display unit 13A, the display unit 13B, and the like described above may be realized by the processor 1001.

In addition, the processor 1001 reads a program (program code), a software module, and data from the storage 1003 and/or the communication device 1004 into the memory 1002 and executes various processes in accordance with this. As the program, a program causing the computer to execute at least some of the operations described in the embodiment described above is used. For example, the acquisition unit 10, the acquisition unit 10A, the acquisition unit 10B, the identifying unit 11, the identifying unit 11A, the identifying unit 11B, the calculation unit 12, the calculation unit 12A, the calculation unit 12B, the display unit 13A, and the display unit 13B may be realized by a control program that is stored in the memory 1002 and is operated by the processor 1001, the other functional blocks may be similarly realized. While various processes described above have been described as being executed by one processor 1001, the processes may be executed by two or more processors 1001 simultaneously or sequentially. The processor 1001 may be realized using one or more chips. In addition, the program may be transmitted from a network through a telecommunication line.

The memory 1002 is a computer-readable recording medium and, for example, may be configured by at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), or the like. The memory 1002 can store a program (a program code), a software module, and the like executable to perform area popularity calculation methods according to the first, second, and third embodiments.

The storage 1003 is a computer-readable recording medium and, for example, may be configured by at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above, for example, may be a database including the memory 1002 and/or storage 1003, a server, or any other appropriate medium.

The communication device 1004 is hardware (a transmission/reception device) for performing inter-computer communication through a wired and/or wireless network and, for example, may also be called as a network device, a network controller, a network card, a communication module, or the like. For example, the acquisition unit 10, the acquisition unit 10A, the acquisition unit 10B, and the like may be realized by the communication device 1004.

The input device 1005 is an input device (for example, a keyboard, a mouse, a microphone, a switch, a button, a sensor, or the like) accepting an input from the outside. The output device 1006 is an output device (for example, a display, a speaker, an LED lamp, or the like) performing output to the outside. In addition, the input device 1005 and the output device 1006 may have an integrated configuration (for example, a touch panel).

In addition, devices such as the processor 1001, the memory 1002, and the like are interconnected through a bus 1007 for communication of information. The bus 1007 may be configured as a single bus or may be configured using buses different for devices.

In addition, the area popularity calculation device 1, the area popularity calculation device 1A, and the area popularity calculation device 1B may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by hardware. For example, the processor 1001 may be realized using at least one of such hardware components.

The notification of information is not limited to the aspect/embodiment described in this specification and may be performed using any other method.

Each aspect/embodiment described in the present specification may be applied to long term evolution (LTE), LTE-advanced (LTE-A), SUPER 3G, IMT-Advanced, 4G, 5G, future ratio access (FRA), W-CDMA (Registered trademark), GSM (registered trademark), CDMA 2000, ultra mobile broadband (UMB), IEEE 802.11 (Wi-Fi), IEEE 802.16 (WiMAX), IEEE 802.20, ultra-wideband (UWB), Bluetooth (registered trademark), a system using another appropriate system and/or a next generation system extended based on these.

The processing sequence, the sequence, the flowchart, and the like of each aspect/embodiment described in the present specification may be changed in order as long as there is no contradiction. For example, in a method described in the present specification, elements of various steps are presented in an exemplary order, and the method is not limited to the presented specific order.

Information and the like may be output from an upper layer (or a lower layer) to a lower layer (or an upper layer). The information and the like may be input and output through a plurality of network nodes.

The input/output information and the like may be stored in a specific place (for example, a memory) or managed using a management table. The input/output information and the like may be overwritten, updated, or additionally written. The output information and the like may be deleted. The input information and the like may be transmitted to another device.

A judgment may be performed using a value (“0” or “1”) represented by one bit, may be performed using a Boolean value (true or false), or may be performed using a comparison between numerical values (for example, a comparison with a predetermined value).

The aspects/embodiments described in the present specification may be individually used, used in combination, or be switched therebetween in accordance with execution. In addition, a notification of predetermined information (for example, a notification of being X) is not limited to be performed explicitly and may be performed implicitly (for example, a notification of the predetermined information is not performed).

As above, while this invention has been described in detail, it is apparent to persons skilled in the art that this invention is not limited to the embodiments described in this specification. This invention can be performed as a modified and changed aspect without departing from the concept and the scope of the present invention defined by the claims. Thus, description of this specification is for the purpose of exemplary description and does not have any meaning for limiting this invention.

It is apparent that software, regardless whether it is called software, firmware, middleware, a microcode, a hardware description language, or any other name, be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, and the like may be transmitted and received via a transmission medium. For example, in a case in which software is transmitted from a website, a server, or any other remote source using wiring technologies such as a coaxial cable, an optical fiber cable, a twisted pair, a digital subscriber line (DSL) and the like and/or radio technologies such infrared rays, radio waves, and microwaves, and the like, such wiring technologies and/or radio technologies are included in the definition of the transmission medium.

Information, a signal, and the like described in the present specification may be represented using any one among different various technologies. For example, data, an instruction, a command, information, a signal, a bit, a symbol, a chip, and the like described over the entire description presented above may be represented using a voltage, a current, radio waves, a magnetic field or magnetic particles, an optical field or photons, or an arbitrary combination thereof.

In addition, a term described in the present specification and/or a term that is necessary for understanding the present specification may be substituted with terms having the same meaning or a meaning similar thereto.

Terms “system” and “network” used in the present specification are compatibly used.

In addition, information, a parameter, and the like described in the present specification may be represented using absolute values, relative values from predetermined values, or other corresponding information.

A name used for each parameter described above is not limited in any aspect. In addition, numerical equations and the like using such parameters may be different from those that are explicitly disclosed in this specification.

Terms such as “determining” used in this specification may include various operations of various types. The “determining,” for example, may include a case in which judging, calculating, computing, processing, deriving, investigating, looking up (for example, looking up a table, a database, or any other data structure), or ascertaining is regarded as “determining.” In addition, “determining” may include a case in which receiving (for example, receiving information), transmitting (for example, transmitting information), input, output, or accessing (for example, accessing data in a memory) is regarded as “determining.” Furthermore, “determining” may include a case in which resolving, selecting, choosing, establishing, comparing, or the like is regarded as “determining ” In other words, “determining” may include a case in which a certain operation is regarded as “determining.”

Terms such as “connected” or “coupled” or all the modifications thereof mean all the kinds of direct or indirect connection or coupling between two or more elements and may include presence of one or more intermediate elements between two elements that are mutually “connected” or “coupled.” Coupling or connection between elements may be physical coupling or connection, logical coupling or connection, or a combination thereof. When used in this specification, two elements may be conceived as being mutually “connected” or “coupled” by using one or more wires, cables and/or print electric connections and, as several non-limiting and non-comprehensive examples, by using electromagnetic energy such as electromagnetic energy having wavelengths in a radio frequency region, a microwave region, and a light (both visible light and non-visible light) region.

Description of “on the basis of” used in this specification does not mean “only on the basis of” unless otherwise mentioned. In other words, description of “on the basis of” means both “only on the basis of” and “at least on the basis of.”

In this specification, in a case in which names such as “first,” “second,” and the like is used, referring to each element does not generally limit the amount or the order of such an element. Such names may be used in this specification as a convenient way for distinguishing two or more elements from each other. Accordingly, referring to the first and second elements does not mean that only the two elements are employed therein or the first element precedes the second element in a certain form.

In addition, a “means” in the configuration of each device described above may be replaced with a “unit,” a “circuit,” a “device,” or the like.

As long as “including,” “comprising,” and modifications thereof are used in this specification or the claims, such terms are intended to be inclusive like a term “comprising.” In addition, a term “or” used in this specification or the claims is intended to be not an exclusive logical sum.

In the entire disclosure, for example, in a case in which articles such as “a,” “an” and “the” in English are added through translation, as long as such articles are not clear on the basis of the context, those include plural forms.

### REFERENCE SIGNS LIST

1, 1A, 1B area popularity calculation device
10, 10A, 10B acquisition unit
11, 11A, 11B identifying unit
12, 12A, 12B calculation unit
13A, 13B display unit
20, 20A, 20B POI category master storing unit
21, 21A, 21B POI master storing unit
22, 22A, 22B POI popularity storing unit
30A event category master
31A event information storing unit

1. An area popularity calculation device comprising circuitry configured to:
acquire area information representing areas on a map;
identify one or more points of interest (POIs) included in a target area represented by the acquired area information; and
calculate a popularity level of the target area on the basis of one or more POI popularity levels respectively associated with the identified one or more POIs.

2. The area popularity calculation device according to claim 1,
wherein the circuitry further identifies one or more events performed inside the target area, and
wherein the circuitry calculates the popularity level further on the basis of the identified one or more events.

3. The area popularity calculation device according to claim 2, wherein the circuitry calculates the number of the one or more events by performing weighting based on the one or more POI popularity levels respectively associated with the one or more POIs at which the one or more events are respectively performed and calculates the popularity level on the basis of the calculated number.

4. The area popularity calculation device according to claim 3,
wherein the one or more POI popularity levels are associated with each day, and
wherein, when the weighting is performed, the circuitry performs weighting based on the one or more POI popularity levels associated with each day of a period in which each of the one or more events is performed.

5. The area popularity calculation device according to claim 3, wherein the circuitry is further configured to perform display based on the calculated popularity level,
wherein the circuitry performs display according to the calculated number.

6. The area popularity calculation device according to claim 2, wherein the circuitry is further configured to perform display based on the calculated popularity level,
wherein the circuitry further displays information relating to periods in which the one or more events are respectively performed.

7. The area popularity calculation device according to claim 2, wherein the circuitry calculates the popularity level for each category of the one or more events.

8. The area popularity calculation device according to claim 1,
wherein the one or more POI popularity levels are associated with each time period, and
wherein the circuitry calculates the number of the one or more POIs by performing weighting based on the one or more POI popularity levels respectively associated with a predetermined time period of each of the one or more POIs and calculates the popularity level on the basis of the calculated number.

9. The area popularity calculation device according to claim 8, wherein the circuitry further configured to perform display based on the calculated popularity level,
wherein the circuitry performs display according to the calculated number.

10. The area popularity calculation device according to claim 1, wherein the circuitry is further configured to perform display based on the calculated popularity level,
wherein the circuitry displays information relating to the one or more POIs respectively associated with the one or more POI popularity levels higher than a predetermined criterion.

11. The area popularity calculation device according to claim 4, wherein the circuitry is further configured to perform display based on the calculated popularity level,
wherein the circuitry performs display according to the calculated number.
